(19) United States
(12) Patent Application Publication
(10) Pub. No.: US 2016/0089647 A1
(43) Pub. Date: Mar. 31, 2016

(54) RE-FILLABLE SYRUP BIN FOR BEVERAGE MACHINE

(71) Applicant: Carrier Corporation, Farmington, CT (US)

(72) Inventor: James J. Minard, Roscoe, IL (US)

(21) Appl. No.: 14/864,273

(22) Filed: Sep. 24, 2015

Related U.S. Application Data
(60) Provisional application No. 62/056,036, filed on Sep. 26, 2014.

(51) Int. Cl. B01F 15/02; B01F 3/08

(52) U.S. Cl. CPC B01F 15/0205; B01F 3/08; B01F 2215/0022

(57) ABSTRACT

A beverage dispenser includes a mixing portion to mix a plurality of beverage ingredients and a dispensing portion to dispense the mixed beverage. The dispenser further includes a product input portion having a plurality of refillable ingredient bins operably connectible to the mixing portion. Each refillable ingredient bin includes a self-closing seal located at a bin outlet to prevent leakage of the beverage ingredients from the bin outlet when the refillable ingredient bin is disconnected from the mixing portion. An ingredient bin assembly for a beverage dispensing machine includes a refillable ingredient bin having a bin outlet and a self-closing seal positioned at the bin outlet to prevent leakage of beverage ingredients from the bin outlet when the refillable ingredient bin is disconnected from a beverage dispensing machine.

### CROSS REFERENCE TO RELATED APPLICATIONS

This application claims the benefit of an earlier filing date from U.S. Provisional Application Ser. No. 62/056,036 filed Sep. 26, 2014, the entire disclosure of which is incorporated herein by reference.

### BACKGROUND

The subject matter disclosed herein relates to beverage machines. More specifically, the present disclosure relates to additive bins for beverage machines.

Syrups and other additives are utilized in beverage machines and dessert machines to flavor drinks, milkshakes, frozen desserts and other products. The syrups are mixed with ice and/or other ingredients or syrups and dispensed from the beverage machine. The syrups are typically provided in single-use bags that connect to the beverage machine. The use of large single-use bags results in a minimum quantity purchases from the syrup supplier by the user of the machine, adding costs particularly for low-volume users.

### SUMMARY

In one embodiment, a beverage dispenser includes a mixing portion to mix a plurality of beverage ingredients and a dispensing portion to dispense the mixed beverage. The dispenser further includes a product input portion having a plurality of refillable ingredient bins operably connectible to the mixing portion. Each refillable ingredient bin includes a self-closing seal located at a bin outlet to prevent leakage of the beverage ingredients from the bin outlet when the refillable ingredient bin is disconnected from the mixing portion.

Alternatively or additionally, in this or other embodiments the seal is secured and/or locked to the ingredient bin via a removable seal holder.

Alternatively or additionally, in this or other embodiments the seal holder is securable to the ingredient bin via a twist-lock feature.

Alternatively or additionally, in this or other embodiments the seal is a silicone seal.

Alternatively or additionally, in this or other embodiments the ingredient bin has a sloping bottom to direct ingredients in the ingredient bin toward the bin outlet.

Alternatively or additionally, in this or other embodiments the ingredient bin includes a removable lid.

Alternatively or additionally, in this or other embodiments the plurality of ingredient bins are positioned in a cabinet.

In another embodiment, an ingredient bin assembly for a beverage dispensing machine includes a refillable ingredient bin having a bin outlet and a self-closing seal positioned at the bin outlet to prevent leakage of beverage ingredients from the bin outlet when the refillable ingredient bin is disconnected from a beverage dispensing machine.

Alternatively or additionally, in this or other embodiments the seal is secured and/or locked to the ingredient bin via a removable seal holder.

Alternatively or additionally, in this or other embodiments the seal holder is securable to the ingredient bin via a twist-lock feature.

Alternatively or additionally, in this or other embodiments the seal is retained at the seal holder between an inner seal holder and an outer seal holder.

Alternatively or additionally, in this or other embodiments the seal is a silicone seal.

Alternatively or additionally, in this or other embodiments the ingredient bin has a sloping bottom to direct ingredients in the ingredient bin toward the bin outlet.

Alternatively or additionally, in this or other embodiments the ingredient bin includes a removable lid.

These and other advantages and features will become more apparent from the following description taken in conjunction with the drawings.

### DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is schematic illustration of an embodiment of a beverage machine;

FIG. 2 is an illustration of an embodiment of a cabinet for a beverage machine;

FIG. 3 is an illustration of an embodiment of an ingredient bin for a beverage machine;

FIG. 4 is a cross-sectional view of an embodiment of a seal for an ingredient bin for a beverage machine;

FIG. 5 is a partially exploded view of an embodiment of an ingredient bin; and

FIG. 6 is a perspective view of an embodiment of a seal assembly for an ingredient bin of a beverage machine.

The detailed description explains embodiments of the invention, together with advantages and features, by way of example with reference to the drawing.

### DETAILED DESCRIPTION

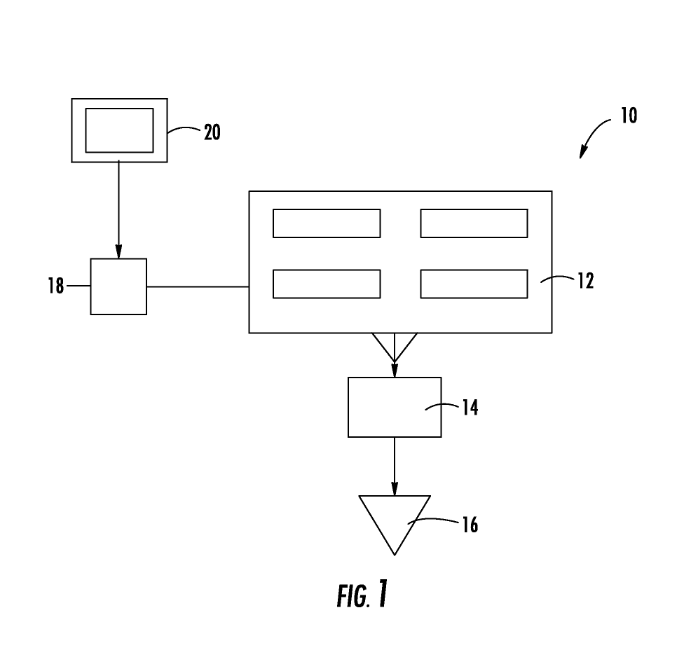

Shown in FIG. 1 is a schematic view of an embodiment of a beverage machine 10. The beverage machine 10 includes a product input portion 12 a mixing portion 14 and a dispensing portion 16. Any number of ingredients, such as syrups, fruit, ice, ice creams, and the like are conveyed from the product input portion 12 into the mixing portion 14 where they are mixed, and then dispensed into a cup or other vessel at the dispensing portion 16. A controller 18 linked to, for example, an input panel 20, receives input from the input panel 20 specifying a selected beverage or product to be dispensed. The controller 18 follows a selected recipe to input ingredients from the product input portion 12 into the mixing portion 14 in required quantities and proportions.

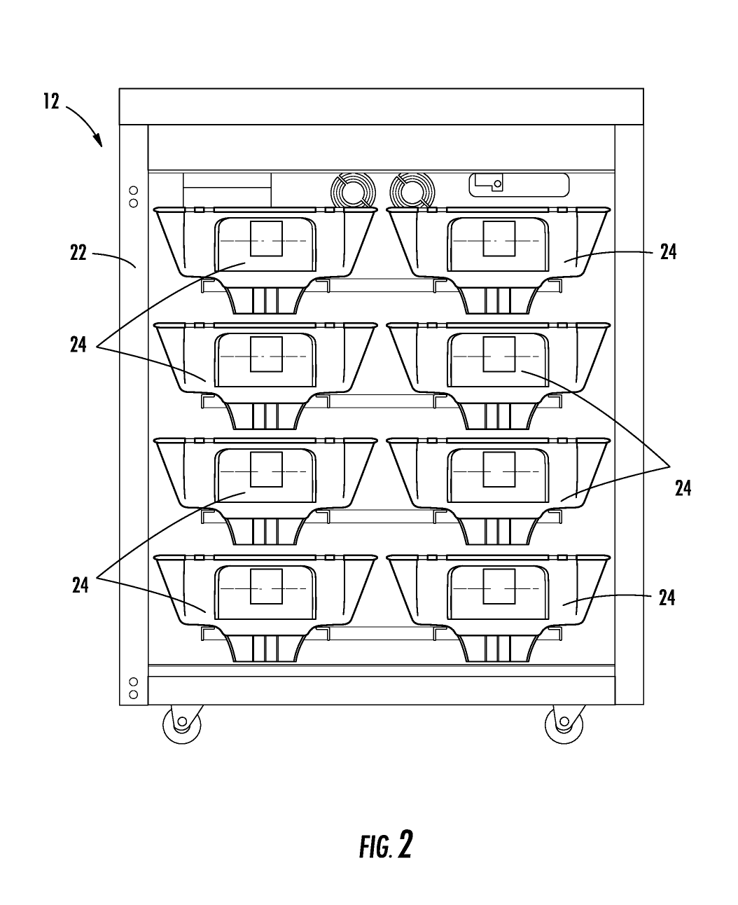

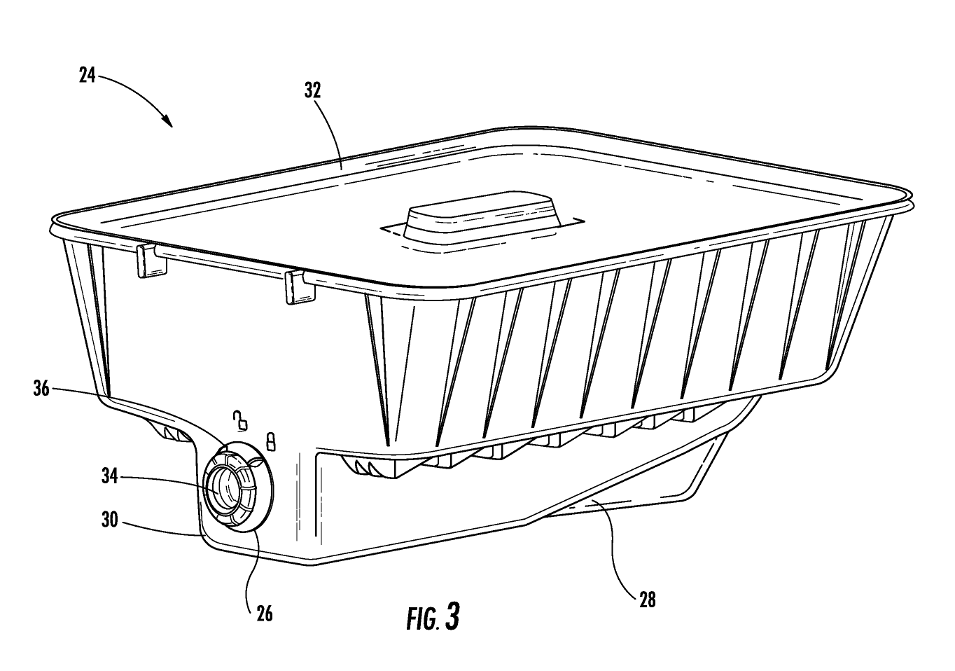

Referring now to FIG. 2, in some embodiments, the product input portion 12 includes a cabinet 22 in which a number of ingredient bins 24 are positioned. Each bin 24 may hold a quantity of an ingredient such as a syrup or other flavoring, and are connected to the mixing portion 14, via a bin outlet 26, as shown in FIG. 3. The bin 24 includes a sloping bottom 28 to direct the syrup toward the bin outlet 26, located at a bin end 30. In some embodiments, the bin 24 further includes a lid 32 to prevent contamination of the syrup inside the bin 24. The bin outlet 26 allows for connection of the bin 24 to an output conduit (not shown) to convey the syrup to the mixing portion 14.

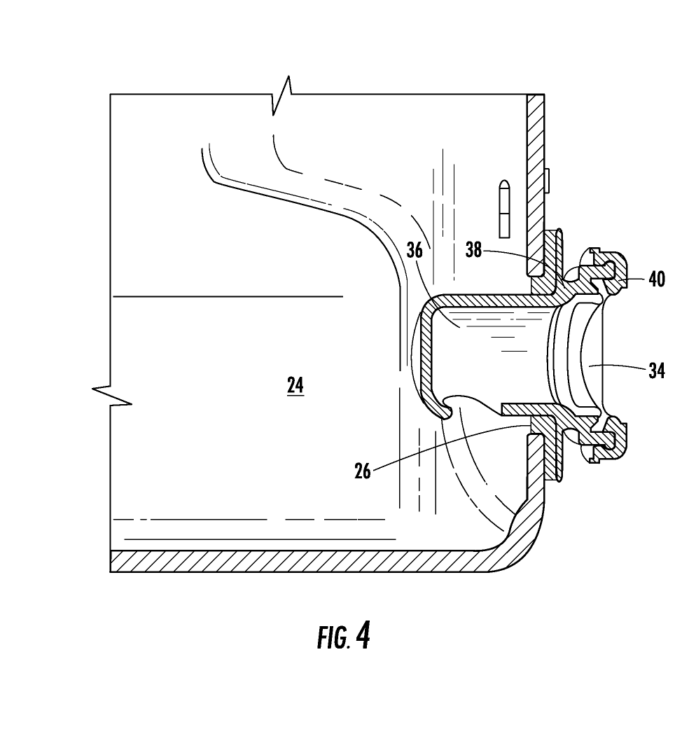

Referring to FIG. 3, a seal 34 is disposed at the bin outlet 26 to seal around the output conduit when the bin is installed thereto and prevent leakage of the syrup out of the bin outlet 26 when the bin 24 is disconnected from the output conduit to, for example, clean or refill the bin 24. The seal 34 is a self-closing silicone seal held in place at the bin outlet 26 by a seal holder 36. In some embodiments, as shown in FIG. 4, the seal 34 is captured and retained between an inner seal holder 38 and an outer seal holder 40 of the seal holder 36.

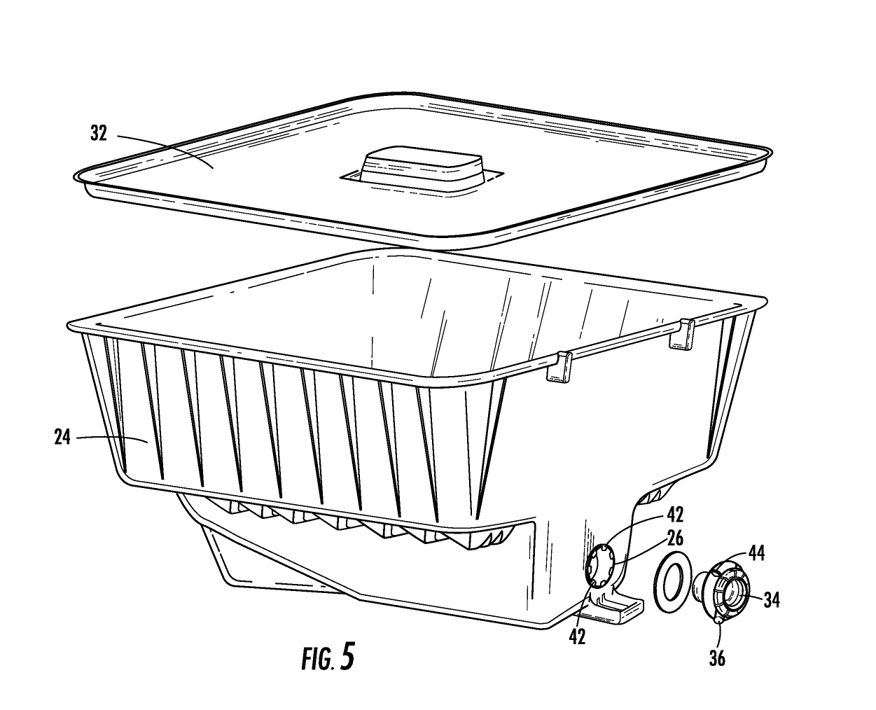

The seal 34 and seal holder 36 are secured to the bin 24 at the bin outlet 26, and are removable from the bin 24 to allow for replacement of the seal 34 when desired, for example, when worn or damaged or at the end of the seal's useful life. In some embodiments, as shown in FIG. 5, the seal holder 36 is installed to the bin opening 26 and secured thereto via a twist-lock engagement. Such engagement is achieved via the use of notches 42 at the bin opening 26 and corresponding tabs 44 at the seal holder 36. To install the seal 34 and seal holder 36 to the bin opening 26, the tabs 44 are aligned with the notches 42 and the seal holder 36 is moved so that the not tabs 44 are at an interior of the bin 24. The seal holder 36 is then twisted, either clockwise or counterclockwise, to lock the seal holder 36 to the bin 24. The seal holder 36 is removed by reversing this sequence of operations. It is not be appreciated that while a twist-lock engagement is utilized in one embodiment, other locking schemes, for example, snaps, mechanical fasteners, or the like may be used.

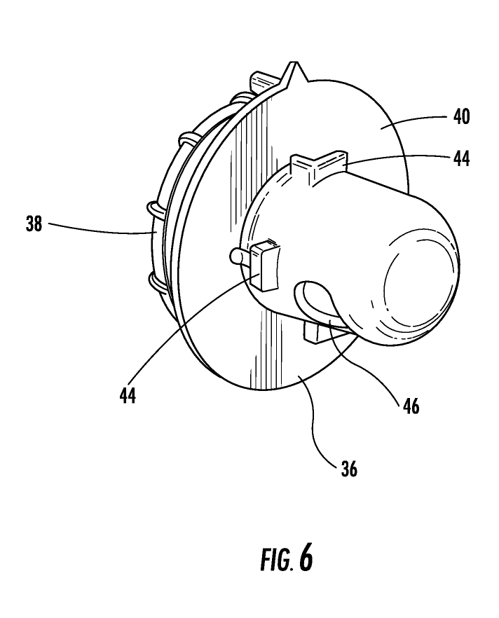

Referring to FIG. 6, the seal holder 36 includes a holder inlet 46, which is an opening to direct syrup flow from the bin 24 toward the seal 34 and output conduit. The holder inlet 46 is oriented to increase bin 24 drainage and to decrease syrup remnants in the bin 24 before the bin 24 must be refilled. For example, in some embodiments the holder inlet 46 is directed slightly downwardly, as shown in FIG. 6.

The embodiments of the bin disclosed herein eliminate the need for a single-use bag, allowing syrup and other ingredients to be added directly to, and dispensed from the bin. By eliminating the bag, and the minimum volume ingredient purchase that accompanies it, the user of the machine is able to supply fresher ingredients, and also may utilize ingredients, such as fruits or flavored syrups, not available in single-use bag form.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in scope. Additionally, while various embodiments have been described, it is to be understood that aspects of the present disclosure may include only some of the described embodiments. Accordingly, the present disclosure is not to be seen as limited by the foregoing description, but is only limited by the scope of the appended claims.

1. A beverage dispenser comprising:
a mixing portion to mix a plurality of beverage ingredients;
a dispensing portion to dispense the mixed beverage; and
a product input portion including a plurality of refillable ingredient bins operably connectible to the mixing portion, each refillable ingredient bin including a self-closing seal disposed at a bin outlet to prevent leakage of the beverage ingredients from the bin outlet when the refillable ingredient bin is disconnected from the mixing portion.

2. The beverage dispenser of claim 1, wherein the seal is secured to the ingredient bin via a removable seal holder.

3. The beverage dispenser of claim 2, wherein the seal holder is securable to the ingredient bin via a twist-lock feature.

4. The beverage dispenser of claim 1, wherein the seal is a silicone seal.

5. The beverage dispenser of claim 1, wherein the ingredient bin has a sloping bottom to direct ingredients in the ingredient bin toward the bin outlet.

6. The beverage dispenser of claim 1, wherein the ingredient bin includes a removable lid.

7. The beverage dispenser of claim 1, wherein the plurality of ingredient bins are disposed in a cabinet.

8. An ingredient bin assembly for a beverage dispensing machine comprising:
a refillable ingredient bin having a bin outlet; and
a self-closing seal disposed at the bin outlet to prevent leakage of beverage ingredients from the bin outlet when the refillable ingredient bin is disconnected from a beverage dispensing machine.

9. The ingredient bin assembly of claim 8, wherein the seal is secured to the ingredient bin via a removable seal holder.

10. The ingredient bin assembly of claim 9, wherein the seal holder is securable to the ingredient bin via a twist-lock feature.

11. The ingredient bin assembly of claim 9, wherein the seal is retained at the seal holder between an inner seal holder and an outer seal holder.

12. The ingredient bin assembly of claim 8, wherein the seal is a silicone seal.

13. The ingredient bin assembly of claim 8, wherein the ingredient bin has a sloping bottom to direct ingredients in the ingredient bin toward the bin outlet.

14. The ingredient bin assembly of claim 8, wherein the ingredient bin includes a removable lid.
